(19) United States
(12) Patent Application Publication
(10) Pub. No.: US 2009/0080191 A1
(43) Pub. Date: Mar. 26, 2009

(54) INDICATING LAMP DEVICE

(75) Inventor: CHIN-YI WU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/964,586

(22) Filed: Dec. 26, 2007

(30) Foreign Application Priority Data
Sep. 25, 2007 (CN) 200710201842.3

(51) Int. Cl. F21V 11/00

(52) U.S. Cl. 362/236

(57) ABSTRACT

An exemplary indicating lamps device includes a casing comprising a panel defining a plurality of through holes therein. The casing houses a plurality of lamps and a plurality of opaque light shields therein. Each lamp includes a light source and a light pillar extending from the light source into the through holes to transmit light emitted by the light source to an exterior of the casing via the corresponding through hole. The opaque light shields are sleeved around circumferential outer surfaces of the light pillars respectively, for preventing light transmitted in the light pillars from leaking out.

### BACKGROUND

1. Technical Field

The present invention relates to lamps and, particularly, to an indicating lamp device.

2. Description of Related Art

Most apparatuses use indicating lamps to indicate operation state or other information of the apparatuses. When several indicating lamps are close to each other, interference between adjacent lamps may occur. When one indicating lamp brightens; the adjacent indicating lamps may also seem to brighten, which can be misunderstood by users.

What is needed, therefore, is an indicating lamp device which avoids light leakage.

### SUMMARY

In accordance with a present embodiment, an indicating lamp device includes a casing comprising a panel defining a plurality of through holes therein. The casing houses a plurality of lamps and a plurality of opaque light shields therein. Each lamp includes a light source and a light pillar extending from the light source into the through holes to transmit light emitted by the light source to an exterior of the casing via the corresponding through hole. The opaque light shields are sleeved around circumferential outer surfaces of the light pillars respectively, for preventing light transmitted in the light pillars from leaking.

Other advantages and novel features will be drawn from the following detailed description of at least one preferred embodiment, when considered in conjunction with the attached drawings.

### BRIEF DESCRIPTION OF THE DRAWINGS

Many aspects of the present indicating lamp device can be better understood with reference to the following drawings. The components in the drawings are not necessarily drawn to scale, the emphasis instead being placed upon clearly illustrating the principles of the present indicating lamp. Moreover, in the drawings, like reference numerals designate corresponding parts throughout the several views.

FIG. 1 is an assembled, isometric view of an indicating lamp device according to a present embodiment.

FIG. 2 is an exploded, isometric view of FIG. 1.

### DETAILED DESCRIPTION OF THE PREFERRED EMBODIMENT

Embodiments of the present embodiment will now be described in detail below and with reference to the drawings.

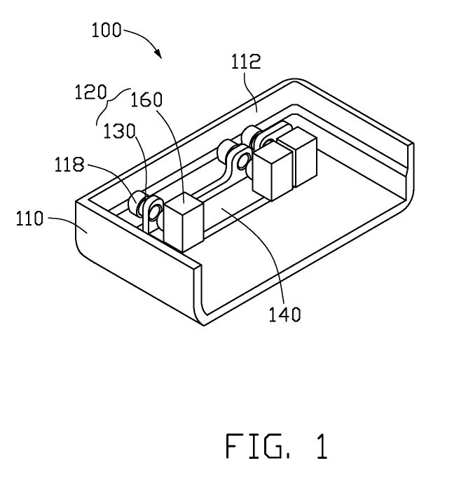

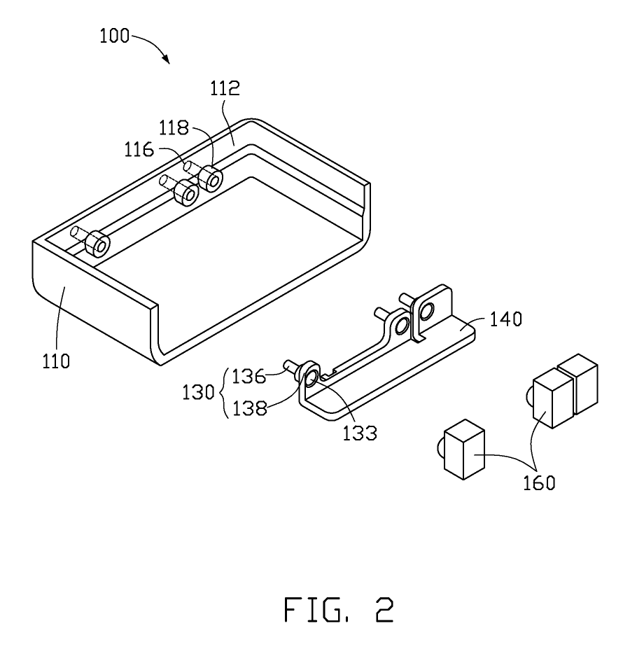

Referring to FIGS. 1-2, an indicating lamp device 100 in accordance with a present embodiment comprises a casing 110, a plurality of lamps 120, a base plate 140, and a plurality of opaque light shields 118. Each lamp 120 comprises a light source 160, and a light pillar 130. The casing 110 is used for housing the lamps 120, the base plate 140, the light shields 118, and other components (not shown) therein. The base plate 140 is secured to the casing 110 and supports the lamps 120 thereon. The light shields 118 are sleeved around the light pillars 130, for preventing light transmitted in the light pillars 130 from leaking out and influencing the appearance of the adjacent lamps 120.

The casing 110 comprises a panel 112 defining a plurality of through holes 116 therein. The light pillars 130 are disposed between the light sources 160 and the panel 110 to transmit light emitted by the light sources 160 to an exterior of the casing 110 via the through holes 116.

Each light pillar 130 comprises a light incident end 138 near the corresponding light source 160 and a light emitting end 136 extending from the light incident end 138 into the corresponding through hole 116. The light incident ends 138 are positioned to the base plate 140 and each have an incident surface 133 facing the corresponding light source 160.

Each light shield 118 is a hollow cylinder in the preferred embodiment, which extends inwardly from an inner surface of the panel 112 and is coaxially aligned with the corresponding through hole 116. In an alternative embodiment, each light shield 118 can be a light shielding layer coated on a circumferential outer surface of the corresponding light pillar 130. It is preferable that the light shields 118 are arranged at circumferential outer surfaces of the emitting ends 136 of the light pillars 130.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. An indicating lamp device comprising:
a casing comprising a panel defining a plurality of through holes therein, the casing housing:
a plurality of lamps each comprising a light source, and a light pillar extending from the light source into the corresponding through hole to transmit light emitted by the light source to an exterior of the casing via the corresponding through hole; and
a plurality of opaque light shields sleeved around circumferential outer surfaces of the light pillars respectively, for preventing light transmitted in the light pillars from leaking out.

2. The indicating lamp device as claimed in claim 1, further comprising a base plate secured to the casing and supporting the lamps thereon.

3. The indicating lamp device as claimed in claim 2, wherein each light pillar comprises a light incident end near the corresponding light source and a light emitting end extending from the light incident end into the corresponding through hole, and wherein the light incident ends are positioned to the base plate and each have an incident surface facing the corresponding light source.

4. The indicating lamp device as claimed in claim 1, wherein each light pillar comprises a light incident end near the corresponding light source and a light emitting end extending from the light incident end into the corresponding through hole, and wherein the opaque light shields are sleeved around the light incident ends of the light pillars.

5. The indicating lamp device as claimed in claim 1, wherein the opaque light shields are hollow cylinders and respectively coaxially aligned with the through holes.

6. The indicating lamp device as claimed in claim 5, wherein the opaque light shields extend inwardly from an inner surface of the panel.
